(19) United States
(12) Patent Application Publication
(10) Pub. No.: US 2007/0042074 A1
(43) Pub. Date: Feb. 22, 2007

(54) Apparatus & molding system for rotating molded articles

(75) Inventors: Josef Graetz, Erin (CA); Svemir Dzafic, Mississauga (CA); Michael E. Nicholas, Beeton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/207,546

(22) Filed: Aug. 19, 2005

(51) Int. Cl. B29C 49/42

(52) U.S. Cl. 425/534

(57) ABSTRACT

Disclosed herein is an apparatus of a molding system and a molding system. The apparatus and the system each include a plurality of mandrels. A selected mandrel of the plurality of mandrels is configured to rotate differently from a manner in which another selected mandrel of the plurality of mandrels is configured to rotate.

### FIELD OF THE INVENTION

The present invention generally relates to molding systems, and more specifically the present invention relates to a molding system and an apparatus of a molding system each including a mandrel configured to rotate a molded article received thereon.

### BACKGROUND

U.S. Pat. No. 4,793,960 to Schad describes a system for injection molding of articles, and reheating the articles prior to blow molding the reheated articles. The system uses pallets to hold preforms during temperature conditioning prior to blowing. Multiple preforms are mounted on each pallet. The pallets pass between heating elements in ovens along a straight path. Each pallet holds multiple preforms on mandrels, which are rotatable, as the pallet passes between the heaters. Also described is the loading of pallets marshaled to accept a complete injection mold shot of parts, and the pallets are subsequently entrained to pass sequentially through a series of temperature conditioning ovens.

U.S. Pat. No. 4,824,359 to Poehlsen describes an injection blow molding machine employing multiple preform holders that move in a circular path from injection station through three successive thermal conditioning stations to a blow molding station.

U.S. Pat. No. 4,063,867 to Janniere describes an injection blow molding machine in which preforms are retained on their cores mounted to a core-carrying bar. Six of these bars are successively loaded into a rotating drum where thermal conditioning of the preforms is carried out while the preforms remain on their respective cores.

U.S. Pat. No. 4,483,436 to Krishnakumar describes a transport pallet for holding twelve preforms in a neck down orientation within rotatable collets. The pallet has rollers at each end of its upper surface and in pairs along its sides for engaging in track means for guiding the transport pallet through the machine and through a thermal conditioning system. The collets are rotatable by means of a friction ring mounted to the collet, which engages the side of the track causing rotation of the collet as the pallet passes along the track.

U.S. Pat. No. 4,963,086 to Wiatt describes a reheat blowing machine that uses a belt drive system for rotating multiple collets on a preform carrier during thermal conditioning.

U.S. Reissue Pat. No. 34,177 to Coxhead describes an oven for reheating preforms passing through it, and the preforms are mounted on pallet mandrels. Heaters of the oven are individually movable by hand to provide a profiled heating arrangement of the preform length. A detent system is used to record individual heater positions so that these are reproduced when specific preform styles are subsequently used.

U.S. Pat. No. 5,834,038 to Ogihara describes reheating preforms using an oven having vertical heaters aligned with the preform vertical axis matching the pitch between the preforms. The heaters are mounted to hinged plates that may alter the vertical alignment angle of the heaters with respect to the preforms.

U.S. Pat. No. 5,853,775 to Oas et al. describes a method and apparatus for forming stretch blow molded containers in which parisons are heated non-uniformly by rotating at a non-uniform rate in a heating station. A sensor determines the angular orientation of the parisons emerging from the heating station. Each parison is angularly reoriented at a repositioning station prior to introduction into a stretch blow molding station having non-round interior surfaces, so that the temperature profile of each parison corresponds with differential expansion required to form a non-round container.

The aforementioned patents appear to suffer from a number of deficiencies. For example, they do not teach the concept of blow molding a preform into an un-symmetrically shaped blown bottle, and the blown bottle needs to receive a cap thereon that must be oriented to the given geometry of the bottle, or the blown bottle needs to receive a label thereon in a manner that is compatible with the given geometry of the bottle. An angular position of the molded article (relative to a longitudinal axis of the article) is not considered before the preform is manipulated for blow molding or for receiving a label thereon, or for stripping from the mandrel and placement onto a conveyor system used to convey the blown article away from the molding system.

U.S. Pat. No. 5,869,110 (Assignee: Nissei ASB Machine Co Ltd., Japan) teaches uniform heating of the preform before blow molding the uniformly heated preform, as indicated at the following sections of the '110.

at column 2 lines 22 to 27. “According to one aspect of the present invention, a temperature conditioning means is provided at a standby section which is disposed between the heating section and the blow molding section. In this standby section, while the temperatures of the inner and outer surfaces are made more uniform, temperature of a part of the surfaces of the preforms to be subject to temperature conditioning can be simultaneously conditioned”.

at column 3 line 53 to column 4 line 3. “In this way, even if the orientation of the part of the surface of the preform to be temperature-conditioned is restricted by the relationship with the temperature conditioning means during the temperature conditioning, the orientation may be changed afterwards as desired by rotating the preform with the rotation drive means. It is therefore possible to change the orientation of the part of the surface to be temperature conditioned as desired, based on the relationship with the blow cavity mold at the blow molding section. In order to rotate the carrier member, it is preferable for the carrier member to further comprise a sprocket. In this case, the rotation drive means may comprise a rack engaging with the sprocket of the carrier member and a linear movement means linearly moving the rack. In particular, the sprocket provided at the carrier member may be used for rotating the preform at the heating section to ensure uniform heating in the circumferential direction.”; and

at column 18 lines 43 to 45: . . . “and because the preform 1 is rotated it receives heat substantially uniformly in the circumferential direction and therefore is heated uniformly in the circumferential direction”.

U.S. Pat. No. 6,287,507 (Assignee: Krupp Corpoplast Maschinenbau GmbH, Germany) teaches rotating a mandrel in a stepwise rotation is carried out with phases of motion and rest by successively timed thermal conditioning of the preform, which is discussed at column 1 lines 42 to 67. “The object of the present invention is therefore to indicate a method of the type mentioned at the beginning by which high quality temperature conditioning can be obtained at low cost. This object is accomplished, according to the invention, in that stepwise tempering is carried out for successively timed thermal conditioning of unlike regions of the preform. An additional object of the present invention is to construct a device of the type mentioned at the beginning so as to permit selective tempering of the preform with high reproducibility. According to the invention, this object is accomplished in that a rotational drive having a steplike mode of operation is provided for performing a motion of rotation of the preform. Stepwise tempering of the preform makes it possible to arrange, for example, along a transport path of the preform, conventional radiant heaters of the prior art with IR radiators and to expose various regions of the preform to radiation for various lengths of time. In this connection in particular, no troublesome coordination between the rate of the longitudinal motion of the preform in the direction of transport and the rate of rotation is required. Implementation of the method using simple equipment may be effected in that stepwise rotation is carried out with phases of motion and rest.”

Canadian Patent 2,403,367 (Assignee: SIG CORPOPLAST GMBH & CO., Germany) describes a method for controlling the temperature of preforms consisting of a thermoplastic material. The preforms are to be blow-molded into containers. The preforms are subjected to a range of temperatures along their periphery and are guided along a translation path, past at least one heating device 14, during the temperature-controlled process. In addition, the preforms are at least occasionally rotated about their longitudinal axes. The control of the rotational movement 8 that is, at least at times, carried out independently of the translation movement. The translation movement is controlled in such a way that the peripheral areas of the preforms, which are to be subjected to a higher temperature, face the heating device for longer periods than the peripheral areas of the preforms, which are to be subjected to a lower temperature. The control has a desired value generator for a temporal modification of the path of the desired value of the rotational speed of the preforms. As shown in FIG. 2, a carrier 15 carries a single mandrel 9, and the mandrel 9 is rotated by a cam follower 8 depending from the carrier 9. The cam follower 8 follows along a track or groove defined in members 3 and 4 as shown in FIG. 1. Disadvantageously, while this apparatus permits either preform translation along a preform travel path or permits preform rotation (along the axis of the preform), this apparatus does not permit concurrent preform translation and preform rotation, and this arrangement limits flexibility for users. Additionally, the preforms must leave the apparatus in one of two angular positions or orientation (that is, either 0 degrees or 180 degrees of axial angular displacement). Also, this apparatus cannot spin the preforms to 90 degrees of axial angular displacement (that is, the displacement relative to the preform's axial angular displacement when initially inserted on the mandrel).

U.S. Pat. No. 4,484,884 (Assignee: Cincinnati Milacron Inc., U.S.A.) describes a machine for high rate production of molecularly oriented thermoplastic bottles. The machine is of the reheat-and-blow type. A blow molding station simultaneously blow molds article preforms arranged in matrices by modular article carriers for conveying the preforms and articles through the machine. The carriers are designed to retain the preforms throughout all operations of the machine from a preform load station through a thermal conditioning section, a blow molding station, and to a bottle eject station, thereby eliminating the need for other preform transferring apparatus. The article carriers together with the associated conveying apparatus comprise a sufficiently flexible structure wherein minor misalignments of the carriers with the blow molding mechanism do not adversely affect bottle production. Both loading of preforms and ejection of finished bottles are accomplished by operation upon matrices of preforms and bottles as defined by the carriers and conveyor lanes. Specific reference is made to column 4 lines 33 to 35. “however, they serve to illustrate that a passage is provided through the center of chuck 208 to preform 20 for injection of the pressurized expansion air”. Also at column 5 lines 20 to 25. “Additionally, the splined support for centering rod 380 through the center of chuck 208 is also shown, further revealing the details of the passage through the chuck that admits the pressurized expansion air into the preform”. Disadvantageously, while this apparatus rotates and translates the preform, the apparatus does not appear to rotate the preform between a minimum value and a maximum value according to a predetermined rotational speed profile. As a consequence, the preform is heated evenly throughout so as to avoid heating one portion of the preform to a hotter temperature than another portion of the preform. It is believed that an evenly heated preform that is blown into an unsymmetrical blow mold cavity may have side walls that are thinner in some portions and thicker in others.

U.S. Pat. No. 6,146,134 and U.S. Pat. No. 6,368,099 (Assignee: Husky Injection Molding Systems Ltd., Canada) describes a system for thermally profiling preforms prior to blow molding. The system includes a pallet for holding a plurality of preforms and a station, such as a heating oven, for thermally conditioning the preforms. In a first embodiment, the pallet comprises a self aligning pallet, which is movable towards and away from the heating oven. In a second embodiment, the pallet holding the preforms is fixed in position and the heating oven is movable towards and away from the preforms. The pallet further includes rotatable mandrels for supporting the preforms and a programmable motor for rotating the preforms a desired amount and at a desired speed. The description for both U.S. Pat. Nos. 6,146,134 and 6,368,099 are the same except that U.S. Pat. No. 6,146,134 covers a system while U.S. Pat. No. 6,368,099 covers a pallet carrier configured to carry preforms. Specific reference is made to U.S. Pat. No. 6,368,099 at column 4 lines 5 to 14. “The self-aligning pallet 36 comprises a bar 50, which carry rotatable mandrels 52 on which are, positioned the preforms 20. As shown in FIG. 4, the mandrels 52 include a primary mandrel 56. The mandrels 52 and 56 have drive wheels 54 that frictionally contact each other or are geared to mesh with each other. The primary mandrel 56 is joined to a motor 58 via a belt 60. When primary mandrel 56 is rotated by the motor 58 via belt 60, the primary mandrel 56 drives all the mandrels 52 on the pallet 36 the same rotational amount and at the same rotational speed but in alternating directions”. Disadvantageously, the arrangement for spinning preforms in alternating directions may prevent thermal conditioning options that are specific to blow molding of unsymmetrical shaped bottles.

### SUMMARY

In a first aspect of the present invention, there is provided an apparatus of a molding system, including a plurality of mandrels, a selected mandrel of the plurality of mandrels is configured to rotate differently from a manner in which another selected mandrel of the plurality of mandrels is configured to rotate.

In a second aspect of the present invention, there is provided a molding system, including an apparatus of a molding system, the apparatus including a plurality of mandrels, a selected mandrel of the plurality of mandrels is configured to rotate differently from a manner in which another selected mandrel of the plurality of mandrels is configured to rotate.

A technical effect of the embodiments of the present invention is an ability to manipulate molded articles selectively according to groups of molded articles, and this provides for improved flexibility for manipulating the molded articles dueing the manufacture thereof.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a side view of an apparatus of a molding system;

FIGS. 2A and 2B are perspective views of a Preform Receiving Device (PRD) that includes the apparatus of FIG. 1;

FIG. 3 is a top view of a preform received by the PRD of FIGS. 2A and 2B;

FIG. 4 is a speed profile of a mandrel included in the PRD of FIGS. 2A and 2B; and

FIG. 5 is a perspective view of the preform of FIG. 3.

### DETAILED DESCRIPTION OF THE EXEMPLARY EMBODIMENTS

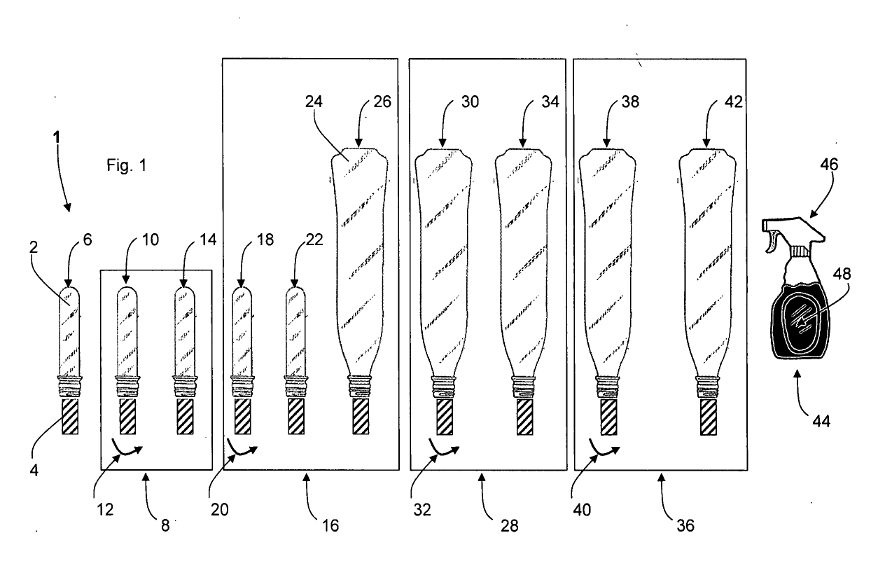

FIG. 1 is a side view of an apparatus 1 of a molding system (not depicted) according to the first embodiment of the present invention. Variations and alternatives of the first embodiment are explained below.

The apparatus 1 includes at least one mandrel 4 (hereinafter referred to as the “mandrel” 4). Optionally, the apparatus 1 also includes a conveying system that moves or translates the mandrel 4, and the apparatus 1 also includes a drive mechanism for rotating the mandrel 4. Examples of the conveying system and the drive mechanism are described further below. The mandrel 4 engages a molded article 2 (for example an inside section of a neck of the molded article 2). The molded article 2 is, for example, an unblown preform and/or a blown preform (that is, a finished, empty bottle).

According to the first embodiment, the apparatus 1 is not included with the molding system. In an alternative of the first embodiment, the apparatus 1 is included with the molding system. The molding system includes a molding machine (not depicted) cooperating with complementary mold halves (not depicted) for molding the molded article 2, and the molding system also includes a blow molding machine (not depicted) for blow molding the molded article 2. Preferably, the molding system also includes manipulation stations 8, 16, 28 and 36, and also includes the conveying system (not depicted) for conveying the mandrel 4 from manipulation station to manipulation station. Positions 6, 10, 14 18, 22, 26, 30, 34, 38 and 42 are positions of the molded article 2 relative to the manipulations stations 8, 16, 28 and 36. The molded article 2 is shown as an unblown preform in positions 6, 10, 14, 18 and 22. The molded article 24 is shown as a blown preform (that is, a finished bottle) in positions 26, 30, 34, 38 and 42. The blow molding machine is used to blow the unblown preform into the blown preform. Types of manipulation stations included in variations of the first embodiment are as follows: a thermal manipulation station, a blow molding station, a labeling station, a stripping (article removing) station, a vision inspection station, a heating station, a cooling station, a spray coating station, a disinfecting station. Any combination and permutation of theses manipulation stations is used according to requirements for manufacturing the molded article 2. Preferably, the manipulation stations 8, 16, 28 and 36 are each configured to carry out a predetermined manipulation on the molded article 2. In a variation of the first embodiment, more than one of a specific type of manipulation station is used if it is deemed required for the manufacture of the molded article 2.

The mandrel 4 is moved (that is, translated) between manipulation stations 8, 16, 28 and 36 (that is, from one manipulation station to another in a serial manner). At position 6, the preform is loaded directly onto the mandrel 4 from the complementary mold halves by using an EOAT (End of Arm Tool: not depicted). Since the orientation of the preform as it exists in the complementary mold halves is known, a rotational orientation of the preform (with respect to a blow mold cavity of the blow molding machine) is also known.

As the mandrel 4 is moved through the manipulation station 8, the station 8 thermally conditions the unblown preform that is received by the mandrel 4. The manipulation station 8 is also called a thermal conditioning station. Heating equipment included in the station 8 is, for example, of the type described in U.S. Pat. No. 6,368,099 assigned to Husky Injection Molding Systems Ltd.

As the mandrel 4 is moved though the manipulation station 16, the station 16 blows the unblown preform into the blown preform as these preforms are held by the mandrel 4. The station 16 is also called a blow molding station that cooperates with the blow molding machine that is used to blow the unblown preform. In variations of the first embodiment that utilize the station 16, the mandrel 4 defines an internal passageway (not depicted) that transmits pressurized expansion air used to blow mold the unblown preform.

As the mandrel 4 is moved through the manipulation station 28, the station 28 positions and places a label onto a side wall of the blown preform (as the mandrel 4 holds onto the blown preform). The station 8 is also called a labeling station.

As the mandrel 4 is moved through the manipulation station 36, the station 36 strips the blown preform from mandrel 4, and then places the blown preform onto a conveyor belt (not depicted). Then, the conveyor belt conveys the blown preform away from the molding system. The station 36 is also called a stripping station.

According to the first embodiment, each manipulation station 8, 16, 28 and 36 is associated with a molded article angular position requirement. The molded article angular position requirement is a predetermined number of degrees that the unblown and/or the blown preform is to be rotated along its longitudinal rotational axis (not depicted) that extends from a neck of the preform to a closed end of the preform.

For the manipulation station 8, it is required that the mandrel 4 rotate the preform received thereon at position 10 by a predetermined angular position. For example, the mandrel 4 is rotated by 30 degrees relative to a known orientation of the preform. The known orientation of the preform is a position in which the preform was placed onto the mandrel 4 by the EOAT (for example). It is required to rotate the mandrel 4 by a predetermined number of degrees according to a given geometry of the blown preform relative to a given geometry of a feature on the preform. For example, the given feature is a thread alignment. The purpose for rotating the preform in this manner is so that a cap or lid is appropriately accommodated by the blown preform relative to the given geometry of the blown preform. The cap includes, for example, a spray mechanism 46 that is compatibly mounted relative to the geometry of the blown preform. An example of a blown preform that has an unsymmetrical shape is shown as bottle 44. Alternatively, the bottle 44 may have a symmetrical shape according to manufacturing requirements. The spray mechanism 46 (when assembled to the bottle 44) is aligned in a compatible manner so that a consistent presentation of the bottle 44 is achieved when a plurality of such bottles are placed on retail store shelves, and a convenient packaging arrangement is achieved when the plurality of bottles are placed in boxes that are shipped to retailers and/or wholesalers of the bottles. The mandrel 4 is translated to position 14 in which thermal energy is then applied to the preform that is received by the mandrel 4. If a variable heating profile around a periphery of the preform is desired to produce non-round blown preforms that require variable degrees of stretching, a variably heated preform is obtained by programming a degree of rotation and speed of rotation of the preform while it is in a heating assembly (not depicted) of the manipulation station 8. The mandrel 4 is rotated according to a rotational speed profile and/or a thermal energy exposure profile of the molded article 2 as described further below.

For the manipulation station 16, it is required that the mandrel 4 rotate the preform received thereon at position 18 by a predetermined angular position (such as for example, the mandrel 4 rotates the preform by 45 degrees relative to the known orientation of the preform). Then, the mandrel 4 is translated to position 22 in which an application of heated air is then injected into the preform to produce the blown preform (shown as item 24) at position 26. The mandrel 4 is configured to transmit pressurized expansion air that is used to blow mold the molded article 2 in cooperation with the blow molding machine. The angle to which the preform is rotated at position 20 is required in order to achieve a desired position between a bottle cap relative to a geometry of the blown preform 24. The blown preform 24 is symmetrically shaped or un-symmetrically shaped.

For the manipulation station 28, it is required that the mandrel 4 rotate the blown preform received thereon at position 32 by a predetermined angular position (such as for example, the mandrel 4 rotates the blown preform by 15 degrees relative to the known orientation of the blown preform). Then the mandrel 4 is translated to position 34 in which a label (not depicted) is placed onto the blown preform. The angle to which the blown preform is rotated at position 32 is required in order to conveniently permit a label placing mechanism (not depicted) to position and apply a label (not depicted) onto the blown preform. The technical effect is to permit convenient placement of a label 48 onto the bottle 44 without having to require undue adaptation of the label placing mechanism relative to the blown preform.

For the manipulation station 36, it is required that the mandrel 4 rotate the blown preform received thereon at position 40 by a predetermined angular position (such as for example, rotate the mandrel 4 by 20 degrees relative to the known orientation of the blown preform). Then the mandrel 4 is translated to position 42 in which the blown preform is then stripped or removed (by a stripping assembly: not depicted) from the mandrel 4 and then placed onto the conveyor belt. The angle to which the preform is rotated at position 40 is required in order to place the blown preform onto the conveyor belt so that the longest dimension of the blown preform is aligned with the direction of movement the conveyor belt. A technical effect of this arrangement is to reduce the chance of tipping the bottle 44 while the bottle 44 it transported by the conveyor belt. Another technical effect of this arrangement is to permit convenient placement of the bottle 44 onto the conveyor belt without having to require undue adaptation of the conveyor belt relative to the bottle 44.

According to the first embodiment, each manipulation station 8, 16, 28 and 36 is associated with a molded article angular position requirement, and the mandrel 4 rotates the molded article 2 received thereon in accordance with a molded article angular position requirement of each manipulation station (that is, stations 8, 16, 28 and 36).

In a variation of the first embodiment, some of the manipulation stations (such as stations 16 and 36) are not associated with molded article angular position requirement while other manipulation stations (such as stations 8 and 28) are associated with a molded article angular position requirement. For stations 16 and 36, the mandrel 4 does not rotate the preform prior to manipulations of the preform. The manipulation stations 8 and 28 (that are associated with a molded article angular position requirement) are members of a set of selected manipulation stations. In this case, the mandrel 4 rotates the molded article 2 received thereon in accordance with a molded article angular position requirement associated with each manipulation station (that is, stations 8 and 28) of the set of selected manipulation stations (that is, stations 8 and 28). The set of selected manipulation stations are stations 8 and 28 for which the mandrel 4 is made to rotate the preform (according to the angular manipulation requirement of respective stations 8 and 28) prior to the stations 8 and 28 manipulating the preform.

In a variation of the first embodiment, a plurality of mandrels (not depicted) is moved through each manipulation station 8, 16, 28 and 36. For example, there is one mandrel that is moved into and out from each manipulation station in a concurrent manner. The mandrels are moved in groups of mandrels either serially or in tandem relative to one another through the manipulation stations 8, 16, 28 and 36.

In another variation of the first embodiment, a selected mandrel (such as the mandrel positioned at position 10 for example) rotates differently from another selected mandrel (such as the mandrel positioned at position 18) is made to rotate.

In other variations of the first embodiment, the molded article angular position requirement includes any one of the following (in any combination and permutation):

clocking the mandrel 4 in a predetermined angular orientation relative to a longitudinally extending rotation axis of the mandrel 4 (that is, rotating the mandrel 4 from an initial angular position to a desired angular position);

clocking of the mandrel 4 occurs before and/or during and/or after the mandrel 4 is moved relative to a specific manipulation station;

clocking the mandrel 4 from a first angular displacement position to a second angular displacement position (for example, the mandrel 4 is rotated from 30 degrees to 45 degrees), and/or

clocking the mandrel 4 from a first angular displacement position to a second angular displacement position before the molded article is manipulated by a manipulation station.

It is to be understood that the term “clocking the mandrel 4” means rotating the mandrel 4 along a longitudinally extending rotation axis of the mandrel 4 by a predetermined angle, such as 30 degrees for example.

In other variations of the first embodiment, the mandrel 4 is configured to be (in any combination and permutation of the following):

place the molded article 2 in an angular orientation relative to a feature of the molded article 2; the feature is, for example, threads placed on the neck of the molded article, and/or a cap snap-on feature placed on the neck portion of the molded article and/or a set of bosses extending from the neck surface, and/or a snap, and/or a bottle closure feature; the feature, preferably, is oriented relative to the final shape of the blown preform and/or are oriented to a desired cap position relative to the final shape of the blown preform; the feature is preferably a pre-configured geometric pattern of the preform; the desired cap includes a liquid-squirting structure that is be attached or coupled to the neck of the blown preform;

place the molded article 2 in an angular orientation relative to a blow geometry of the blown preform (as shown in position 26 for example); and/or

rotate in any one rotatable direction of clockwise (along a longitudinally extending rotation axis of the mandrel), counter clockwise and any combination and permutation thereof.

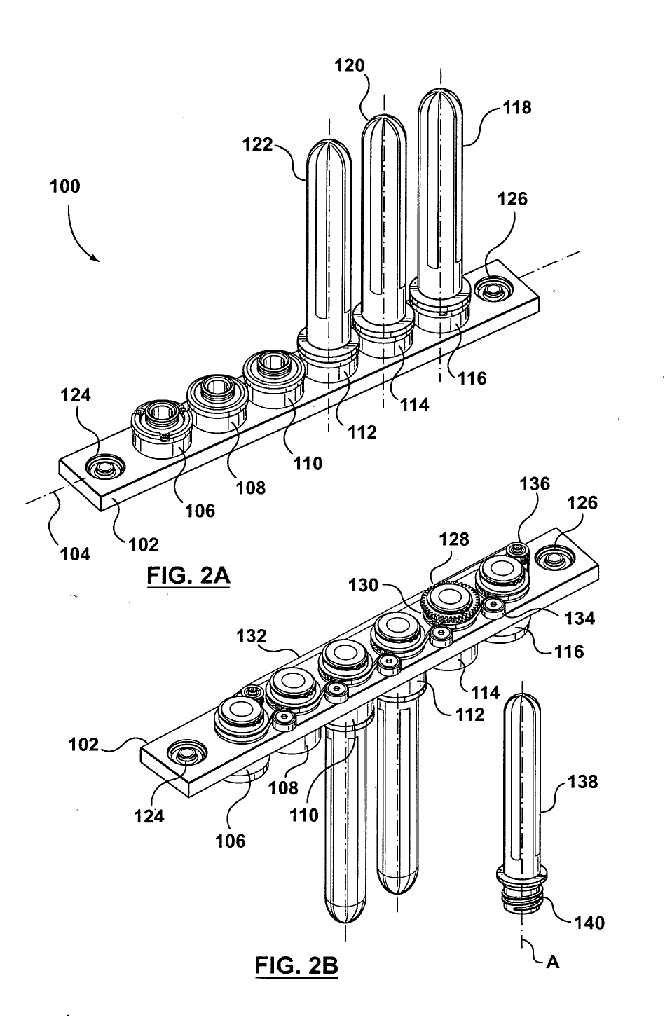

FIGS. 2A and 2B are perspective views of a Preform Receiving Device (hereinafter referred to as the “PRD” 100) according to the second embodiment of the present invention (which is the preferred embodiment). The PRD 100 includes the apparatus 1 of FIG. 1. Variations and alternatives of the second embodiment are explained further below.

FIG. 2A shows a perspective view of a first side (that is, the top side) of the PRD 100. The PRD 100 includes a body 102. The body 102 has a longitudinal axis 104 extending therethrough. The PRD 100 also includes a set of mandrels 106, 108, 110, 112, 114 and 116 all of which operate according to the manner in which the mandrel 4 of FIG. 1 operates, and additional operational features (according to the second embodiment) of the mandrels 106, 108, 110, 112, 114 and 116 are described further below. The set of mandrels 106 to 116 rotatably mount to the body 102 and they align along the longitudinal axis 104 of the body 102. The set of mandrels 106 to 116 include at least one mandrel.

The PRD 100 is an example of the conveying system for moving or conveying the mandrel 4 of FIG. 1 from one manipulation station to another. The body 102 is made to travel or move along a traversal pathway into and away from the manipulation stations. In an alternative, the body 102 is attached to the conveying system as of the type (which is a rotating, horizontally-aligned table) described in U.S. Pat. No. 6,368,099 assigned to Husky Injection Molding Systems Ltd. Alternatively, the conveying system is a chain-driven conveyor (or a belt-driven conveyor) in which the body 102 is attached to a drive chain or a belt drive accordingly.

According to the second embodiment, the set of mandrels has six mandrels. In alternatives, the set of mandrels includes 2, 5, 10, 20 mandrels or other suitable number of mandrels as required to suit the manufacture of the molded articles at a desired quantity per hour. Each mandrel 106 to 116 receives a respective molded article (such as the preforms depicted in FIGS. 2A and 2B). For example, mandrel 116 receives preform 118, mandrel 114 receives preform 120 and mandrel 112 receives preform 122. A distal end of the preform 122 points upwardly and away from mandrel 112. For clarity, mandrels 106, 108 and 110 are shown not receiving a preform. The preform, according to the second embodiment, is a PET preform.

The set of mandrels 106 through to 116 are rotatable synchronously in phase relative to other mandrels of the set of mandrels. That is, either the mandrels all rotate clockwise or all rotate counter clockwise in a synchronous manner (both in direction of rotation and in amount of rotational speed). In an alternative, each mandrel 106 to 116 synchronously orients their respective preform to a predetermined cross-sectional angle before the body 102 is shuttled, while the body 102 is shuttled, after the body 102 is shuttled and any combination and permutation thereof.

According to the second embodiment, the set of mandrels 106 to 116 transmit pressurized, expansion air having sufficient pressure to expand and blow the preform into a blow mold cavity (not depicted) of a blow mold machine (not depicted). Alternatively, the set of mandrels 106 to 116 transmit pressurized air having sufficient heat for heating an interior space of the preform prior to the blow molding machine blowing the preform into a final, desired shape or a desired geometry.

FIG. 2B shows a perspective view of a second side (that is, the bottom side) of the PRD 100. Mandrels 112 and 110 are each shown engaging a respective preform. The PRD 100 may operate in an orientation as depicted in FIG. 2A or may operate in another orientation as depicted in FIG. 2B provided the mandrels securely engage with a respective preform. In an alternative embodiment, a distal end of the mandrels includes a rubber tip or suitable resilient member adapted or sized to friction fit or frictionally engage an inside section of a neck of a preform. In use, the body 102 may be oriented in either manner as depicted in FIGS. 2A or 2B. It is preferred to orient the body 102 as shown in FIG. 2A over orientating the body 102 as shown in FIG. 2B.

The drive mechanism for rotating the set of mandrels is now described as follows: the mandrel 114 includes a toothed gear 128. The gear 128 is connectable to a stepper motor (not depicted). The stepper motor is controlled by a programmable controller (not depicted). The controller is programmed to rotate the mandrel 114 according to the predetermined rotation speed profile as described below. In an alternative embodiment, the stepper motor is replaced with a servo motor, a synchronous AC motor, a hydraulic-based drive, a pneumatic-based drive, or other drive system configured to rotate the set of mandrels of the PRD 100 according to a variable rotation speed profile that varies between a maximum rotational speed and a minimum rotational speed. The controller is replaceable by a control mechanism configured to control the drive mechanism.

Preferably, mandrel 114 also includes another toothed gear 130 that is disposed below the gear 128. A toothed belt 132 engages the gear 130. Each mandrel 106 to 116 includes a toothed gear that is equivalent to the toothed gear 130. The belt 132 is aligned to engage each of the toothed gears associated with a respective mandrel 106 to 116. When the stepper motor is energized to rotate the gear 128, the gear 128 rotates in response that then urges the belt 132 to translate along a belt travel pathway. Since each gear associated with each mandrel 106 to 116 engages the belt 132 as the belt 132 moves each mandrel of the PRD 100 rotates synchronously. Each mandrel 106 to 116 is rotated, for example, clockwise (that is, they all rotate in the same direction). Preferably, the drive mechanism includes a roller 134 and a tension adjustment mechanism 136. The roller 134 is used to curve the belt 132 around a portion of the gear 130 so as to improve traction and engagement therewith. Mechanism 136 is used to improve general tension biasing of the belt 132.

In an alternative embodiment, an O-ring belt or other toothless belt is used as a replacement for the toothed belt 132. Alternatively, the belt 132 is removed and the gear 130 of each mandrel of the PRD 100 is adapted to interact with an adjacent gear of an adjacent mandrel of the PRD 100 so that with this arrangement some mandrels of the set of mandrels rotates clockwise while other mandrels will rotate counter-clockwise. Alternatively, an idler gear is interposed between the gears of each mandrel so that each mandrel of the set of mandrels rotates in the same direction in unison.

In FIG. 2B, a preform 138 is shown not connected to a mandrel. The preform 138 has a longitudinal axis extending therethrough from a neck area 140 to a closed end. The closed end is located opposite from the neck area 140. The neck area 140 has threads formed thereon. In an alternative, the preform 138 does not include threads formed thereon.

In an alternative embodiment to that depicted in FIG. 2B, the mechanisms 128, 130, 132, 134 and 136 are located on the top side of the body 102. It is preferred to locate these mechanisms on the bottom side of the body 102 as shown in FIG. 2B.

In an alternative, the PRD 100 also includes another body (not depicted) having another longitudinal axis extending therethrough, and another set of mandrels (not depicted) including at least one mandrel, each mandrel of another set of mandrels is also configured in the same way as the mandrels of the body 102. The mandrels of another body and the mandrels of the body 102 rotate according to respective rotational speed profiles that are distinct from one another. This is achieved by dedicating a respective drive mechanism for each of the body 102 and the another body so that the mandrels of each body are driven separately according to a respective rotational speed profile of a respective drive mechanism.

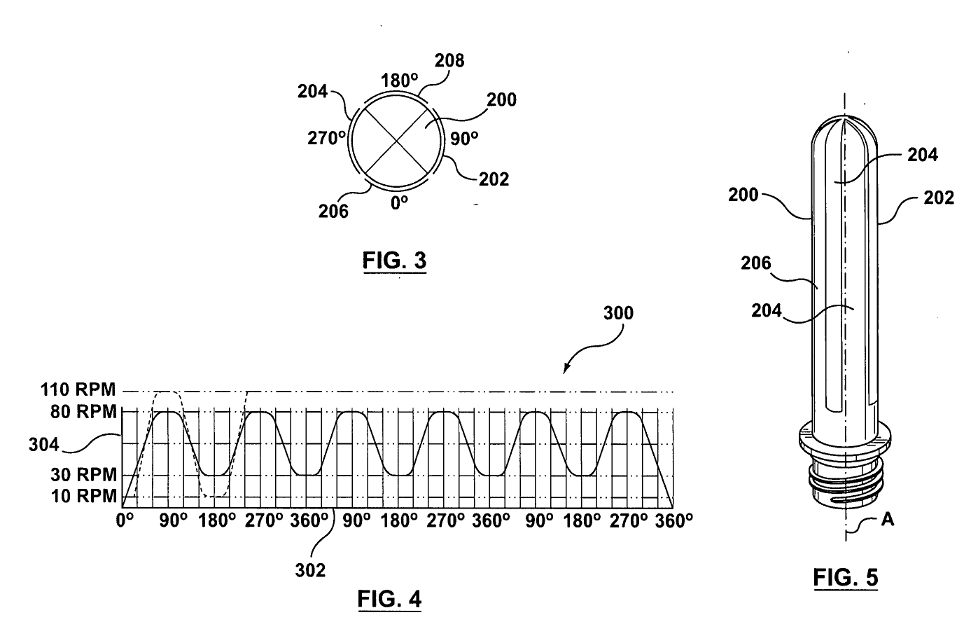

FIG. 3 is a top view of a preform 200 received by a mandrel of the PRD 100 of FIGS. 2A and 2B. The preform 200 is heated according to a preferential thermal conditioning approach. To achieve desired material distribution (that is, even wall thickness) for blown preforms, predetermined areas of the preform 200 are heated more than other areas. This is especially desirable for blown preforms that have an odd shape (that is, a non-circular shape) such as having a triangular-shaped, a rectangular-shaped or an oval-shaped cross section, and it is especially desirable when the blown preforms must have threads oriented in a desired angle when presented to the blow molding machine. Some blown preforms are assembled with a trigger-actuated spray nozzle mounted to the neck of the blown preform, and it is desired to have the nozzles aligned in a preferred orientation. For the preform 200, it is determined that it is desired to apply little or no heat to areas 202 and 204 and to apply relatively more heat to areas 206 and 208 while maintaining thread orientation of the preform 200 during application of heat energy.

FIG. 4 is a graph of a predetermined rotational speed profile of a mandrel of the PRD 100 included in the PRD 100 of FIGS. 2A and 2B. X-axis 302 indicates a rotational angle of the preform 200 of FIG. 2, while Y-axis 304 indicates the rotational speed profile of the mandrel of the PRD 100. In order to apply more heat to areas 206 and 208, the preform 200 is rotated according to the predetermined rotation speed profile of the mandrel of the PRD 100. Preferably, the speed profile is achieved by way of the mandrel operatively attached to a stepper motor (that is, a drive mechanism) under control of a programmable digital controller. The set of mandrels 106 to 116 are rotated in unison according to the predetermined rotational speed profile. In an alternative, other approaches are used to control the drive mechanism for rotating the mandrels, such as using limit switches or position switches attached to the stepper motor for example.

In an alternative, to control the rotational speed profile of the set of mandrels of the PRD 100, the ratio of time spent between “hot” areas 206 and 208 and “cold” areas 202 and 204 ranges from between about 2:1 to about 5:1. Also, the preform 200 is rotated a full three rotations within a manipulation station. In addition, a temperature difference between the “hot” areas 206 and 208 and the “cold” areas 202 and 204 is made to vary from between about 10 degrees Celsius to about 20 degrees Celsius. As well, the rotational speed profile is made to vary from between about 30 RPM (revolutions per minute: a minimum rotational speed value) to about 90 RPM (a maximum rotational speed value). These identified ranges are wider or narrower as required to suit a specific application of heat energy.

FIG. 5 is a perspective view of the preform 200 of FIG. 3, in which the preform 200 has received a preferential heat treatment.

The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

1. An apparatus of a molding system, comprising:
a plurality of mandrels, a selected mandrel of the plurality of mandrels is configured to rotate differently from a manner in which another selected mandrel of the plurality of mandrels is configured to rotate.

2. The apparatus of claim 1, wherein:
the plurality of mandrels includes:
a first group of mandrels configured to mount a first body; and
a second group of mandrels configured to mount a second body;
wherein the selected mandrel is a member of the first group of mandrels, and
wherein the another selected mandrel is a member of the second group of mandrels.

3. The apparatus of claim 1, wherein:
the plurality of mandrels is configured to:
be movable between manipulation stations, and
rotate a molded article received thereon in accordance with a molded article angular position requirement of each manipulation station of a set of selected manipulation stations.

4. The apparatus of claim 3, wherein:
the molded article angular position requirement includes any one of the following in any combination and permutation of:
clocking the plurality of mandrels in an predetermined angular orientation,
clocking the plurality of mandrels from a first angular displacement position to a second angular displacement position, and
clocking the plurality of mandrels from the first angular displacement position to the second angular displacement position before the molded article is manipulated by a manipulation station.

5. The apparatus of claim 3, wherein:
the molded article angular position requirement includes clocking the plurality of mandrels before moving the plurality of mandrels, while moving the plurality of mandrels, after moving the plurality of mandrels and any combination and permutation thereof.

6. The apparatus of claim 3, wherein:
the manipulation stations includes a thermal manipulation station, a blow molding station, a labeling station, a stripping station, a vision inspection station, a heating station, a cooling station, a spray coating station, a disinfecting station and any combination and permutation thereof.

7. The apparatus of claim 3, wherein:
the molded article angular position requirement includes any one of the following in any combination and permutation of:
a rotational speed profile of the plurality of mandrels, and
a thermal energy exposure profile of the molded article.

8. The apparatus of claim 3, wherein:
the manipulation stations are each configured to carry out a predetermined preform manipulation.

9. The apparatus of claim 3, wherein:
the plurality of mandrels is configured to any one of:
place the molded article in an angular orientation relative to a feature of the molded article,
place the molded article in an angular orientation relative to a blow geometry of a blown molded article,
rotate independently of translation of the plurality of mandrels,
rotatably mount a body, and the body is configured to be transported between the molded article manipulation stations,
cooperate with an end-of-arm robotic tool,
is a member of a set of mandrels, each mandrel of the set of mandrels is configured to rotate synchronously by a drive mechanism, and
any combination and permutation thereof.

10. The apparatus of claim 3, wherein:
the plurality of mandrels is configured to rotatably mount a body, the body is configured to be transported between the molded article manipulation stations, the body has a longitudinal axis extending therethrough; and
the plurality of mandrels is configured to align along the longitudinal axis.

11. The apparatus of claim 1, wherein:
the molded article is a blowable preform; and
the plurality of mandrels is configured to transmit pressurized expansion air, the pressurized expansion air is configured to blow mold the molded article in cooperation with a blow molding machine.

12. The apparatus of claim 1, wherein:
the plurality of mandrels includes:
a first group of mandrels configured to mount a first body, and each mandrel of the first group of mandrels rotate in unison; and
a second group of mandrels configured to mount a second body, and each mandrel of the second group of mandrels rotate in unison.

13. The apparatus of claim 1, wherein:
the plurality of mandrels is configured to rotate synchronously by a drive mechanism, the drive mechanism includes any one of a toothless belt, a toothed belt, an O-ring belt, a toothed gear, a toothless gear and any combination and permutation thereof.

14. The apparatus of claim 1, wherein:
the plurality of mandrels is configured to rotate synchronously by a drive mechanism, the drive mechanism includes any one of a stepper motor, a servo motor, a synchronous AC motor and any combination and permutation thereof.

15. The apparatus of claim 1, wherein:
the molded article is any one of an unblown preform and a blown preform.

16. The apparatus of claim 1, wherein:
the molded article is molded by complementary mold halves configured to cooperate with a molding machine.

17. A molding system, comprising:
an apparatus of a molding system, including:
a plurality of mandrels, a selected mandrel of the plurality of mandrels is configured to rotate differently from a manner in which another selected mandrel of the plurality of mandrels is configured to rotate.

18. The molding system of claim 17, wherein:
the plurality of mandrels includes:
a first group of mandrels configured to mount a first body; and
a second group of mandrels configured to mount a second body;
wherein the selected mandrel is a member of the first group of mandrels, and
wherein the another selected mandrel is a member of the second group of mandrels.

19. The molding system of claim 17, wherein:
the plurality of mandrels is configured to:
be movable between manipulation stations, and
rotate a molded article received thereon in accordance with a molded article angular position requirement of each manipulation station of a set of selected manipulation stations.

20. The molding system of claim 19, wherein:
the molded article angular position requirement includes any one of the following in any combination and permutation of:
clocking the plurality of mandrels in an predetermined angular orientation,
clocking the plurality of mandrels from a first angular displacement position to a second angular displacement position, and
clocking the plurality of mandrels from the first angular displacement position to the second angular displacement position before the molded article is manipulated by a manipulation station.

21. The molding system of claim 19, wherein:
the molded article angular position requirement includes clocking the plurality of mandrels before moving the plurality of mandrels, while moving the plurality of mandrels, after moving the plurality of mandrels and any combination and permutation thereof.

22. The molding system of claim 19, wherein:
the manipulation stations includes a thermal manipulation station, a blow molding station, a labeling station, a stripping station, a vision inspection station, a heating station, a cooling station, a spray coating station, a disinfecting station and any combination and permutation thereof.

23. The molding system of claim 19, wherein:
the molded article angular position requirement includes any one of the following in any combination and permutation of:
a rotational speed profile of the plurality of mandrels, and
a thermal energy exposure profile of the molded article.

24. The molding system of claim 19, wherein:
the manipulation stations are each configured to carry out a predetermined preform manipulation.

25. The molding system of claim 19, wherein:
the plurality of mandrels is configured to any one of:
place the molded article in an angular orientation relative to a feature of the molded article,
place the molded article in an angular orientation relative to a blow geometry of a blown molded article,
rotate independently of translation of the plurality of mandrels,
rotatably mount a body, and the body is configured to be transported between the molded article manipulation stations,
cooperate with an end-of-arm robotic tool,
is a member of a set of mandrels, each mandrel of the set of mandrels is configured to rotate synchronously by a drive mechanism, and
any combination and permutation thereof.

26. The molding system of claim 19, wherein:
the plurality of mandrels is configured to rotatably mount a body, the body is configured to be transported between the molded article manipulation stations, the body has a longitudinal axis extending therethrough; and
the plurality of mandrels is configured to align along the longitudinal axis.

27. The molding system of claim 17, wherein:
the molded article is a blowable preform; and
the plurality of mandrels is configured to transmit pressurized expansion air, the pressurized expansion air is configured to blow mold the molded article in cooperation with a blow molding machine.

28. The molding system of claim 17, wherein:
the plurality of mandrels includes:
a first group of mandrels configured to mount a first body, and each mandrel of the first group of mandrels rotate in unison; and
a second group of mandrels configured to mount a second body, and each mandrel of the second group of mandrels rotate in unison.

29. The molding system of claim 17, wherein:
the plurality of mandrels is configured to rotate synchronously by a drive mechanism, the drive mechanism includes any one of a toothless belt, a toothed belt, an O-ring belt, a toothed gear, a toothless gear and any combination and permutation thereof.

30. The molding system of claim 17, wherein:
the plurality of mandrels is configured to rotate synchronously by a drive mechanism, the drive mechanism includes any one of a stepper motor, a servo motor, a synchronous AC motor and any combination and permutation thereof.

31. The molding system of claim 17, wherein:
the molded article is any one of an unblown preform and a blown preform.

32. The molding system of claim 17 wherein:
the molded article is molded by complementary mold halves configured to cooperate with a molding machine.
